(19) United States
(12) Patent Application Publication
(10) Pub. No.: US 2016/0033753 A1
(43) Pub. Date: Feb. 4, 2016

(54) IMAGE ACQUIRING APPARATUS

(71) Applicant: CANON KABUSHIKI KAISHA, Tokyo (JP)

(72) Inventors: Hiroshi Saito, Ayase-shi (JP); Michio Yanagisawa, Utsunomiya-shi (JP)

(21) Appl. No.: 14/810,949

(22) Filed: Jul. 28, 2015

(30) Foreign Application Priority Data
Jul. 31, 2014 (JP) 2014-156794

(51) Int. Cl. G02B 21/36; G06T 3/40

(52) U.S. Cl. CPC G02B 21/367; G02B 21/362; G06T 3/4038; G06T 2207/20212; G06T 2200/32; G06T 2207/10056

(57) ABSTRACT

An image acquiring apparatus configured to acquire an image of an object, including: an imaging optical system; an image taking element; a changing mechanism configured to change a posture of the object or the image taking element; a control unit configured to calculate a control target value; and a correcting mechanism configured to correct the posture such that a reached posture approaches the target posture, wherein the control unit compares reached image data obtained as a result that the image taking element actually takes an image of a correction chart whereof drawing information is known in a state that the posture is the reached posture, and target image data which is expected to be obtained when the image taking element takes an image of the correction chart in a state that the posture is the target posture to calculate a correction value of the posture.

### BACKGROUND OF THE INVENTION

1. Field of the Invention

This disclosure relates to an image acquiring apparatus.

2. Description of the Related Art

An image acquiring apparatus configured to acquire digital images by imaging an object (mount) attracts attention in a field of pathology and the like. The image acquiring apparatus enables a doctor to diagnose a pathological condition by using acquired image data. Since the diagnosis by the doctor is required to be accurate and speedy, the image data is required to be acquired at a high speed, and the acquired image data is required to be an image which contributes to easy diagnosis. In order to do so, it is effective to take an image of the mount at once over the largest possible area at a high resolution.

If an angle of view of an objective lens is increased to enlarge an image size which can be acquired at once, the image data can be acquired at a high speed. However, acquisition of an image focused over an entire angle of view becomes difficult. This is because a surface to be imaged of the object is not flat and has “waviness”, and hence part of image taking surface may not be included within a depth of focus of the objective lens.

In view of such a problem, US2013/0169788 discloses an image acquiring apparatus having a plurality of image taking systems and capable of changing at least one (posture) of a position and an inclination of each of the plurality of the image taking systems. By setting the plurality of the image taking systems to take their own positions, the posture of the image taking surface with respect to the objective lens can be changed. The postures of the respective image taking systems are controlled so that the entire image taking surface is included within the depth of focus of the objective lens by measuring the waviness of the surface to be imaged of the object.

Japanese Patent Laid-Open No. 2012-078330 discloses a technology of a lens inspection instrument configured to measure by moving a camera unit for correcting a movement of a camera unit automatically so that measurement of a lens being tested can be performed accurately and simply irrespective of a positioning accuracy of a three-axis stage to be moved. Specifically, before mounting the lens to be tested on a lens mount, a check plate is mounted on as a jig for focus checking, and a center portion and a peripheral portion of a pattern printed on the plate are imaged by the camera unit, whereby a best focus position is obtained. On the basis of a difference between a position of the camera unit at which the best focus is obtained at the center portion and a position at which the best focus is obtained in the peripheral portion, a correction coefficient in a direction of an optical axis when moving the camera unit in an in-plane direction perpendicular to the optical axis by a three-axis stage.

As disclosed in US2013/0169788, when controlling the posture of the image taking system, even when a driving device is controlled so as to achieve a target posture, a resulting posture may become unintended posture since a movement component of another axis (different axis movement component) different from an intended operating axis is superimposed to an intended movement component. For example, in the case where the image taking system is controlled so that the inclination with respect to the optical axis is changed, the posture may be misaligned with the target posture by the movement of the position also in a direction perpendicular to the optical axis. The movement in the direction perpendicular to the optical axis is a different axis movement component.

If there is the different axis movement component, part of the image taking surface which has controlled so as to follow waviness of the surface to be imaged moves out of the depth of focus, so that a blurring image may be acquired. Therefore, a portion excluding a peripheral edge portion of an effective pixel area of the image taking system is treated as a usable area for formation of the image data (image formation), so that an effective usage of pixels is interfered.

However, in US2013/0169788 and Japanese Patent Laid-Open No. 2012-078330, a specific method of correcting the different axis movement component as described above is not disclosed. In addition, in the different axis movement component is caused by a mechanism error, deformation, a measurement error, a control computation error, and the like, and a state of variation is not monotonous, and regularity and reproducibility such as a non-linear shape, hysteresis, and a change with time are low. Therefore, even when a compensation coefficient for an assumed target value is acquired and a correction is performed on the basis of this coefficient, sufficient effects may not be obtained.

### SUMMARY OF THE INVENTION

An aspect of this disclosure is an image acquiring apparatus configured to acquire an image of an object by joining a plurality of divided images obtained by taking images of a plurality of divided areas in the object, including: an imaging optical system configured to image light from the object; an image taking element configured to take an image of the object; a changing mechanism configured to change a posture of the object or the image taking element; a control unit configured to calculate a control target value for causing the changing mechanism to reach a target posture; and a correcting mechanism configured to correct the posture such that a reached posture after the changing mechanism has changed the posture in accordance with the control target value so as to approach the target posture, wherein the control unit compares reached image data obtained as a result that the image taking element actually takes an image of a correction chart whereof drawing information is known in a state that the posture is the reached posture, and target image data which is expected to be obtained when the image taking element takes an image of the correction chart in a state that the posture is the target posture to calculate a correction value of the posture, and the correcting mechanism corrects the posture on the basis of the correction value.

Further features of the present invention will become apparent from the following description of exemplary embodiments with reference to the attached drawings.

### BRIEF DESCRIPTION OF THE DRAWINGS

FIG. 1 is a schematic configuration drawing illustrating an image acquiring apparatus of a first embodiment.

FIG. 2 is a schematic drawing of an image taking unit of the first embodiment.

FIG. 3 is a schematic drawing of an individual image taking unit of the first embodiment.

FIG. 4 is an explanatory drawing illustrating a configuration of a moving mechanism of the first embodiment.

FIG. 5 is an explanatory drawing illustrating a configuration of a retaining member and a moving member of the first embodiment.

FIG. 6 is a functional block diagram of a control unit of the first embodiment.

FIG. 7 is an explanatory drawing of an example of a changing mechanism of an image taking element of the first embodiment.

FIG. 8 is an explanatory drawing illustrating an influence of a different axis movement component.

FIG. 9 is an explanatory drawing illustrating a relationship between a sample and an image taking area of the image taking unit.

FIG. 10 is an explanatory drawing illustrating a relationship between an imaging surface of an optical flux from the sample and an image taking surface.

FIG. 11 is an explanatory drawing illustrating divided areas of a surface to be imaged.

FIG. 12 is a drawing illustrating an example of a correction chart of the first embodiment.

FIG. 13A is a drawing illustrating an example of a drawing portion of the correction chart of the first embodiment.

FIG. 13B is an explanatory drawing illustrating a relationship between the image taking surface and the correction chart of the first embodiment.

FIG. 14 is an explanatory drawing illustrating a relationship between imaging of the optical flux and the image taking surface from the correction chart.

FIG. 15A is a drawing illustrating an example of a target image data.

FIG. 15B is a drawing illustrating an example of a reached image data.

FIG. 16 is a schematic drawing illustrating another example of the correction chart.

FIG. 17 is a flowchart of an image acquisition method of the first embodiment.

FIG. 18 is a flow chart of a method of determining a procedure for a stage and a moving mechanism of the first embodiment.

FIG. 19 is a schematic drawing of a configuration of an image acquiring system of a second embodiment.

FIG. 20 is a flowchart of an image acquisition method of the second embodiment.

### DESCRIPTION OF THE EMBODIMENTS

In an image acquiring apparatus described in embodiments given below, a transmission-type digital microscope is described as the image acquiring apparatus and a mount is described as an object as an object of acquisition of the image as preferable examples. However, this disclosure is not limited thereto. Numerical values exemplified for specifically describing the disclosure are not limited unless otherwise specifically noted. In the respective drawings, the same members are denoted by the same reference numerals and overlapped description is omitted.

### First Embodiment

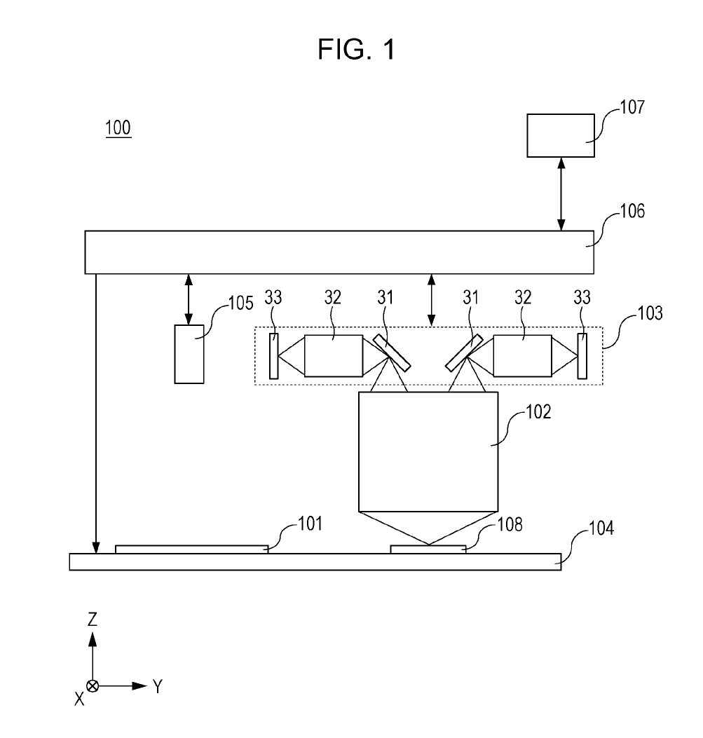

Referring now to FIG. 1, a configuration of an image acquiring apparatus 100 (hereinafter, referred to as an “apparatus 100”) will be described. FIG. 1 is a schematic drawing illustrating a configuration of the apparatus 100. In the following description, a direction of an optical axis of an objective lens 102 is defined as a Z direction, directions perpendicular to the direction of the optical axis is defined as an X direction and a Y direction.

The apparatus 100 includes the objective lens 102, an image taking unit 103, a stage 104, a preliminary measuring unit 105, a control unit 106, a display unit 107, a correcting chart 108 installed on the stage 104 (hereinafter, referred to as a “chart 108”).

A mount 101 is an image-acquired object (object) which is an object of the image acquisition. The mount 101 includes a cover glass, a sample 11 such as a sample of a living body, that is, a section of tissue, and a slid glass, and the sample 11 arranged on the slide glass is sealed with a cover glass and an adhesive agent. The mount 101 is arranged on the stage 104, is measured preliminary by the preliminary measuring unit 105, and then moved by the stage 104 on the basis of a preliminary measurement result, and the image of the mount 101 is taken by the image taking unit 103 via the objective lens 102.

The objective lens 102 has an imaging optical system configured to image the mount 101 and, specifically, is an imaging optical system for forming an image on reflecting surfaces of reflecting members 31 in the image taking unit 103 described later while enlarging an image of the mount 101 at a predetermined magnification. The objective lens 102 is retained by a body frame and a lens barrel, which are not illustrated, and is configured by a combination of a lens and a mirror. The objective lens 102 is arranged so that the reflecting surfaces of the reflecting members 31 of the image taking unit 103 and the mount 101 are optically conjugated, an object side corresponds to the mount 101, and an image side corresponds to the reflecting surface. A numerical aperture NA on the object side of the objective lens 102 is 0.7 or larger, and can be configured so that an image of an area of at least 10 mm×10 mm on an object surface can be formed desirably at once.

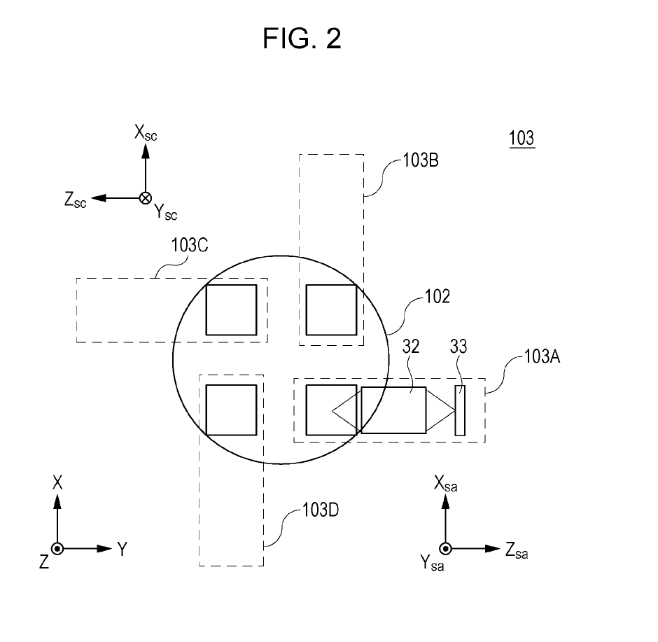

The image taking unit 103 has a plurality of individual image taking units 103A to 103D at a portion which takes an image of the mount 101 imaged by the objective lens 102. The image taking unit 103 is retained by the body frame or the lens barrel of the objective lens, which are not illustrated. FIG. 2 is a top view of the image taking unit 103. As illustrated in FIG. 2, the plurality of the individual image taking units 103A to 103D are arrayed two-dimensionally within a view of the objective lens 102, and configured to be capable of taking an image of a plurality of different areas on the mount 101 at the same time.

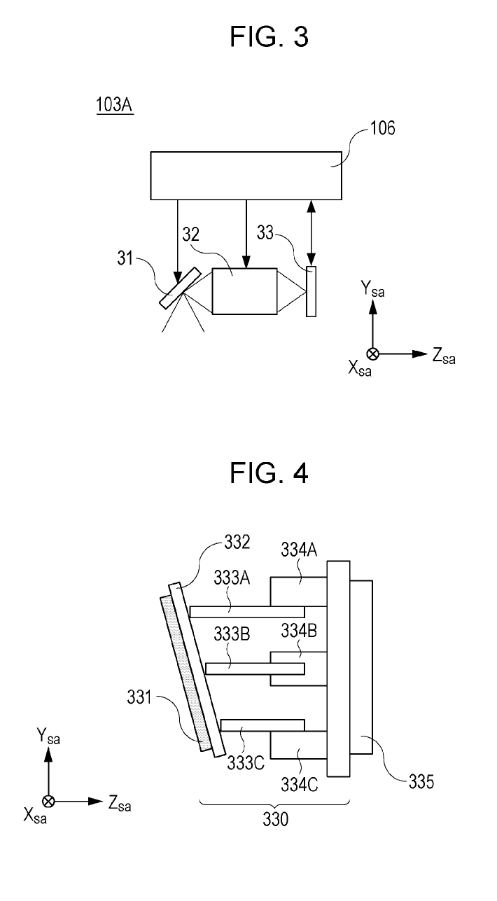

The configuration of the individual image taking units 103A to 103D will be described with reference to FIG. 3. FIG. 3 is a configuration drawing of the individual image taking unit 103A. The individual image taking unit 103A includes the reflecting member 31, a re-imaging unit 32, and an image taking element 33. The reflecting member 31 reflects an optical flux imaged from a given area on the mount 101 via the objective lens 102. The re-imaging unit 32 images the optical flux from the reflecting members 31 on an image taking surface of the image taking element 33, the image taking element 33 takes an image on the image taking surface and output image data as the image taking result to the control unit 106. The individual image taking unit 103A is provided with a movement mechanism for changing the posture of the image taking element 33 (330 in FIG. 4) and a mechanism configured to be capable of controlling the postures of the reflecting members 31 and the re-imaging unit 32, respectively. The “image taking surface” of this specification corresponds to a light-receiving surface of the image taking element 33.

The reflecting surface of the reflecting member 31 and the image taking surface of the image taking element 33 are arranged so as to be optically conjugated with respect to the re-imaging unit 32. The object side corresponds to the reflecting surface, and the image side corresponds to the image forming surface. Also, an optical axis of the objective lens 102 and an optical axis of the re-imaging unit 32 are orthogonal to each other via the reflecting member 31. A (two-dimensional) image taking element such as a CCD or a CMOS sensor may be used as the image taking element 33. The individual image taking units 103B to 103D have the same configuration.

The number of the individual image taking units mounted on the apparatus 100 is determined as needed depending on a surface area of the field of view of the objective lens 102. The arrangement and the configuration of the individual image taking units to be mounted are also determined as needed depending on the shape of the field of view of the objective lens 102 and the shape and the configuration of the image taking element 33. In this embodiment, as an example, 2×2 individual image taking units 103A to 103D are arranged on an X-Y plane. The individual image taking units 103A to 103D may include a plurality of reflecting members 31, or may have a configuration in which the reflecting member 31 and the re-imaging unit 32 are not provided and the images imaged by the objective lens 102 are directly taken by the image taking element 33.

Here, in the case where the postures of the respective image taking element 33 are described in the following description, a coordinate system illustrated in FIG. 2 is used. In the coordinate system illustrated in FIG. 2, when the mount 101 is moved in the Z direction, the direction in which the corresponding image moves is defined as a Zₛ direction. In the same manner, when the mount 101 is moved in the X direction or the Y direction, the directions in which the corresponding image moves are defined as an Xₛ direction and a Yₛ direction, respectively. Therefore, the Xₛ direction, the Yₛ direction, and the Zₛ direction of the individual image taking units 103A to 103D are different from each other. In order to clarify the respective coordinate system, the posture of the individual image taking unit 103A is expressed with an Xₛₐ direction, a Yₛₐ direction, and a Zₛₐ direction, and the posture of the individual image taking unit 103B is expressed with an X_{sb} direction, Y_{sb} direction, and a Z_{sb} direction. The postures of the remaining individual image taking units 103C and 103D are the same and, if the Xₛ direction, for example, the posture of the image taking unit 103C is expressed with an X_{sc} direction and the posture of the individual image taking unit 103D is expressed as an X_{sd} direction.

In general, the individual image taking unit includes an area such as a substrate on which the image taking elements 33 are mounted in the periphery of the image taking surface of the image taking element 33, and hence it is difficult to arrange the plurality of the image taking elements 33 adjacently without gap. Therefore, it is not easy to arrange the individual image taking units 103A to 103D having the image taking element 33 adjacent to each other, and is obliged to arrange apart from each other as illustrated in FIG. 2. In this case, images of portions corresponding to the gap between the individual image taking units 103A to 103D cannot be taken at one shot and may be missing. Accordingly, in the apparatus 100, image taking is performed by a plurality of times while changing a relative position between the mount 101 and the image taking unit 103 for filling the gap by moving the stage 104. In other words, the image taking unit 103 takes images of a plurality of different areas on the mount 101 to acquire divided image data of the respective areas. The control unit 106 joins the acquired divided image data, so that a configuration in which an image data of the mount 101 having no missing portions can be acquired is achieved. By performing this action at a high speed, an image over a large area is acquired while reducing time required for the image acquisition.

FIG. 4 is an explanatory drawing illustrating a configuration of a movement mechanism 330 for changing the posture of the image taking element 33. The movement mechanism 330 includes an image taking element mounting substrate 331 (hereinafter, referred to as a “substrate 331”), a retaining member 332, moving members 333A to 333C, changing mechanism 334A to 334C, and correcting mechanism 335 configured to correct the reached posture after the substrate 31 has controlled in accordance with the control target value. The substrate 331 is a member on which the image taking element 33 is arranged, and the substrate 331 is retained by the retaining member 332.

The retaining member 332 is fixed to the moving members 333A to 333C, and the changing mechanisms 334A to 334C move the moving members 333A to 333C, so that the posture of the image taking element 33 can be changed. A mechanism using a linear actuator having a linear motor, an air cylinder, a stepping motor, or an ultrasonic wave motor, and the like may be used as the changing mechanism 334A to 334C and the correcting mechanism 335. A rotating function around the Zₛₐ axis may be added to the correcting mechanism 335.

FIG. 5 is a drawing illustrating the retaining member 332 from the Zₛₐ direction. As illustrated in FIG. 5, three each of the moving members 333A to 333C and the changing mechanism 334A to 334C are provided for a single image taking element 33. The moving members 333A to 333C are fixed to the retaining member 332, and a member which can be bent adequately, that is, a member having a relatively low rigidity around the both axes of Xₛₐ and Yₛₐ in comparison with the rigidity in the Zₛₐ direction. Therefore, by moving the three moving members 333A to 333C in the Zₛₐ direction, the position of the image taking surface in the Zₛₐ direction of the image taking element 33 can be changed, and the inclination of the image taking surface can be changed.

The stage 104 is a position changing unit configured to change the position of the mount 101 by moving in the state of supporting the mount 101. The stage 104 includes a supporting portion configured to support the mount 101, an XY stage configured to move the supporting portion in the XY direction, and a Z stage configured to move the supporting portion in the Z direction (these members are not illustrated). The XY stage and the Z stage move the supporting portion in accordance with the control target value output from the control unit 106.

The XY stage (not illustrated) is configured to allow the mount 101 to move between a range which can be preliminary measured by the preliminary measuring unit 105 of the apparatus 100 (preliminary measurement range) and a range in which image can be taken by the image taking unit 103 (image taking executing range). In the image taking executing range, the relative position between the mount 101 and the image taking unit 103 is changed by moving the XY stage as illustrated in FIG. 2 to allow a plurality of times of image taking by the image taking unit 103.

The preliminary measuring unit 105 has a function to perform measurement for acquiring a present area of the sample 11 included in the mount 101 in the preliminary measurement range and a function to perform measurement for acquiring information on a surface to be imaged 15 of the sample 11. The measurement for acquiring the information on the surface to be imaged 15 is, for example, measurement of waviness on the upper surface of the cover glass included in the mount 101. A specific configuration of this case may be the same as that disclosed in US2013/0169788, and detailed description will be omitted here.

Alternatively, a configuration further including measurement of the thickness of the cover glass included in the mount 101 and the measurement result thereof and a measurement result of the waviness on the upper surface of the cover glass are used to acquired information on waviness on a lower surface of the cover glass close to the upper surface of the sample 11 is also applicable. Alternatively, a configuration including a measuring function for measuring the amount of change of contrast and the amount of transmissive light with respect to illumination light having a specific wavelength from the image taking result obtained by taking images of the plurality of the different positions in the Z direction of the sample 11 included in the mount 101 is also applicable.

The control unit 106 controls the respective configurations of the apparatus 100 and generates the image data for observation by using the image taking result of the image taking unit 103. The control unit 106 is composed of a multi-purpose computer or a work station providing a high-speed arithmetic processing such as a CPU, a memory and a hard disk, and a specific graphic board, or a combination thereof. The control unit 106 includes an interface, which is not illustrated, which allows the user to change the setting of the apparatus 100 or to input drawing information of the chart 108 described later.

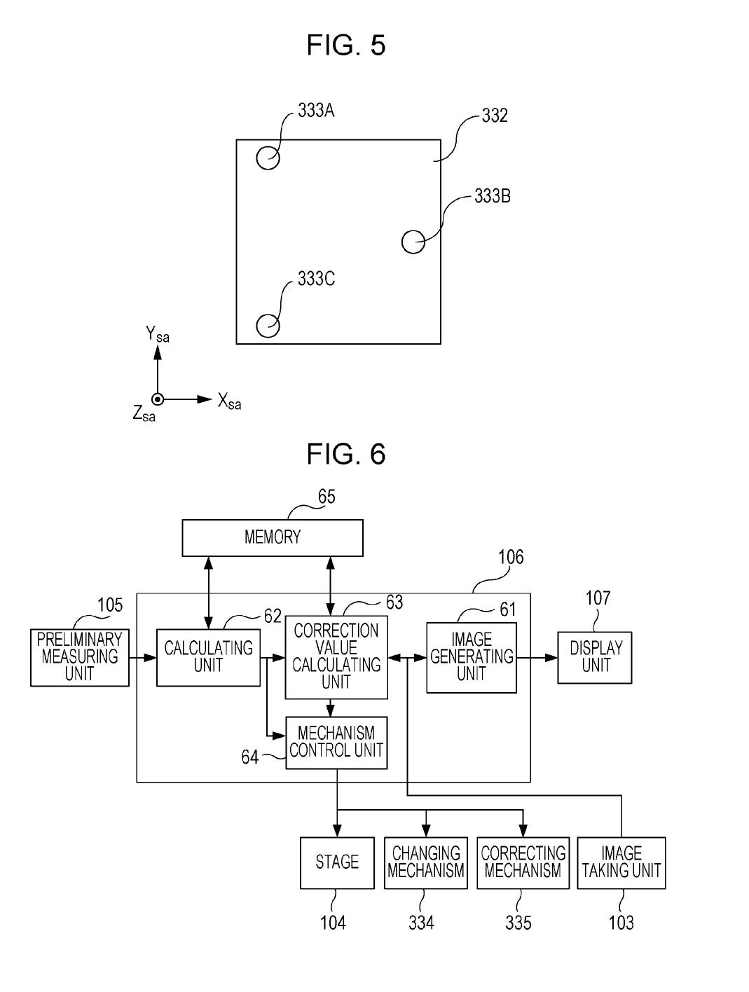

FIG. 6 is a functional block diagram of the control unit 106. As illustrated in FIG. 6, the control unit 106 includes an image generating unit 61 (hereinafter, referred to as a “generating unit 61”), a target value calculating unit 62 (hereinafter, referred to as a “calculating unit 62”), a correction value calculating unit 63 (hereinafter, referred to as a “calculating unit 63”), and a mechanism control unit 64.

The generating unit 61 has a function to generate observation image data by processing the image data of the mount 101 acquired by the image taking unit 103. Specifically, positions of a plurality of divided image data acquired by a plurality of times of image taking while moving the stage 104 in the XY direction are aligned and these divided image data are connected to generate the observation image data so as to be displayed in the display unit 107.

The calculating unit 62 obtains a control target value of the mechanism control unit 64 for controlling the stage 104 of the apparatus 100 on the basis of the preliminary measurement result measured by the preliminary measuring unit 105. A configuration in which the mount 101 is preliminary measured by an apparatus other than the apparatus 100 and, the result is acquired to calculate the control target value is also applicable. Specifically, the present area of the sample 11 included in the mount 101 is acquired by using the preliminary measurement result of the preliminary measuring unit 105. On the basis of the present area of the sample 11, the surface to be imaged 15 for generating the observation image data is selectively determined. The calculating unit 62 divides the surface to be imaged 15 into divided areas that the single image taking element 33 can take the image at once, and determines the order of image taking among the respective divided areas and the position to which the stage 104 is to be moved for taking the images of the respective divided areas. Here, a control target value table in which the order of movement of the stage 104 and the position thereof are shown is generated.

The mechanism control unit 64 is capable of controlling the movement of the stage 104 on the basis of the acquired control target value table, and acquiring only the image data of the area to be imaged. Accordingly, the image data of the area required for the pathological diagnosis may be selectively acquired, and hence the capacity of the observation image data may be reduced, so that handling of the observation image data is facilitated. Normally, the surface to be imaged 15 is determined so as to be equal to the area where the sample 11 is present.

The calculating unit 62 acquires information on the surface to be imaged 15 of the sample 11 included in the mount 101 from the measurement result of the preliminary measuring unit 105. On the basis of the magnifications of the objective lens 102 and the re-imaging unit 32, an imaging surface (imaging curve) on which the optical flux from the surface to be imaged 15 of the sample 11 images via the objective lens 102 is calculated. Approximate planes of the imaging surfaces are calculated for the respective divided areas, and control target values of the changing mechanism 334A to 334C of the image taking element 33 required for aligning the respective image taking surfaces of the individual image taking units 103A to 103D with the acquired approximate planes are determined. On the basis of the control target value, the mechanism control unit 64 controls the changing mechanism 334A to 334C to change the posture of the image taking element 33, so that a desired image with less out-of focus can be acquired.

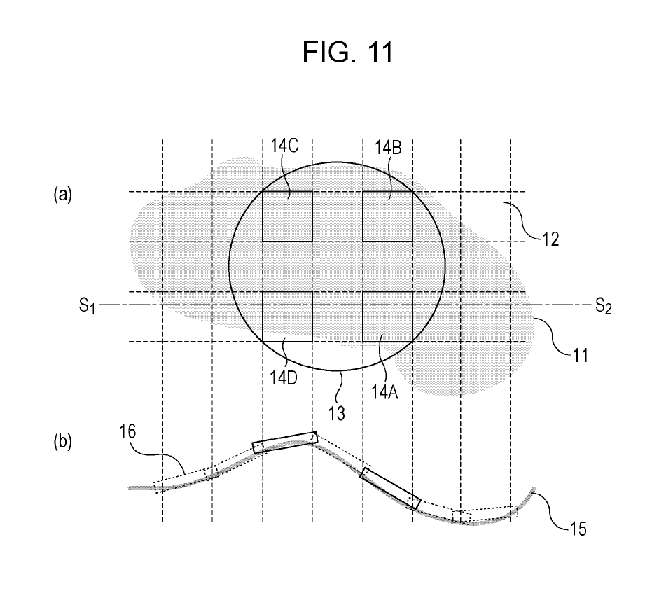

FIG. 11 is an explanatory drawing illustrating the divided areas, and illustrates the object side of the objective lens 102. Part (a) of FIG. 11 is a drawing of the sample 11 viewed from the Z direction, and Part (b) of FIG. 11 is a cross-sectional view taken along the line S₁-S₂. As illustrated in Part (a) of FIG. 11, the sample 11 is divided into a plurality of divided areas 12. The divided areas 12 are areas in which the single image taking element 33 can take an image at once. The individual image taking units 103A to 103D take images of areas 14A to 14D in a field of view 13 of the objective lens 102, respectively, among the plurality of the divided areas 12. From then onward, the areas 14A to 14D that the image taking elements 33 of the individual image taking units 103A to 103D can take images at once are referred to as the image taking areas 14A to 14D. As illustrated in the S₁-S₂ cross section in Part (b) of FIG. 11, the surface to be imaged 15 of the sample 11 is not plane and has waviness. Therefore, the individual image taking units 103A to 103D are required to change the postures so that the respective image taking areas 14A to 14D follow the surface to be imaged 15 as illustrated by a posture control example 16.

Accordingly, the calculating unit 62 divides the surface to be imaged 15 of the sample 11 into the divided areas 12, and calculates control target value of the stage 104 so that the respective divided areas move efficiently to XY positions of the image taking areas 14A to 14D. Approximate planes of the imaging surfaces projected from the respective divided areas 12 are calculated by the calculating unit 62, and control target values of the changing mechanism 334A to 334C of the image taking element 33 required for aligning the respective image taking surfaces with the calculated approximate planes are determined. The mechanism control unit 64 controls the stage 104 and the changing mechanism 334A to 334C so that the relationship between the surface to be imaged 15 and the image taking areas 14A to 14D of the image taking unit 103 becomes as the posture control example 16 on the basis of the control target value that the calculating unit 62 acquires.

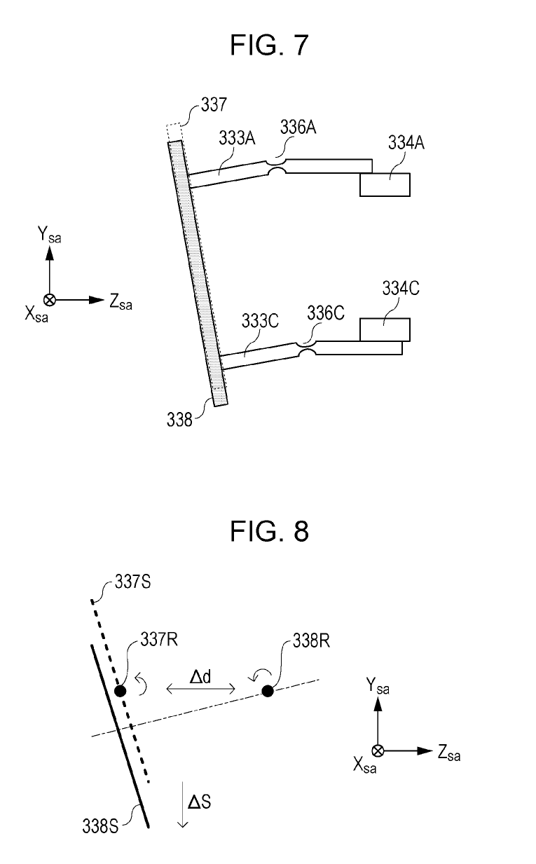

An example of the configuration of the movement mechanism 330 of the image taking element 33 is illustrated in FIG. 7. In FIG. 7, for the sake of simplifying description, the case where only the moving members 333A and 333C and the changing mechanism 334A and 334C are provided will be described. Although an example in which the posture control is performed on the individual image taking unit 103A in the direction of rotation (θxₛₐ) about the Xₛₐ axis is illustrated, the control is not limited to the direction of θxₛₐ. Other individual image taking units 103B to 103D have the same configuration.

In FIG. 7, the movement control is performed on the moving member 333A in an opposite direction from the changing mechanism 334A (−Zₛₐ direction) and on the moving member 333C in the direction approaching the changing mechanism 334C (+Zₛₐ direction) on the basis of the control target value calculated by the control unit 106 from the preliminary measurement result. With this control, a resilient portion 336A of the moving member 333A and a resilient portion 336C of the moving member 333C are deformed, and the substrate 331 reaches a reached position 338. A reached posture 338 is a state in which a movement component in the −Yₛₐ direction is superimposed with a position of an ideal movement (target posture) 337 aside from the rotation about an operating axis Xₛₐ. In other words, it is a state in which a movement component of an axis different from the rotation about the Xₛₐ axis (different axis movement component) ΔS is superimposed with the reached posture 338.

The different axis movement component will be described with reference to FIG. 8 in detail. In order to move the image taking surface of the image taking element 33 mounted on the substrate 331 to a target position 337S in a state in which the image taking element 33 maintains the target posture, it is ideal to control the postures of the substrate 331 and the image taking element 33 so as to rotate about a center of rotation 337R. Actually, however, a position 338R which is apart from the center of rotation 337R by a distance Δd becomes the center of rotation, and consequently, the image taking surface of the substrate 331 moves to the reached position 338S. In other words, the different axis movement component ΔS is superimposed, and the image taking surface of the image taking element 33 may move to the position (reached position) 338S different from the target position 337S.

This is caused by a presence of a physical distance such as the length of the moving members 333A and 333C, the thickness of the substrate 331 and the thickness of the retaining member 332 between the resilient portion 336A and 336C and the image taking surface as illustrated in FIG. 4 and FIG. 7. Possibly this is caused by a measurement errors occurring in the changing mechanism 334A to 334C, control computation errors occurring in the control unit 106, mechanism errors or deformation occurring entirely in the movement mechanism 330. For example, in the case where mounting of the changing mechanism 334A to 334C is inclined in the Yₛₐ direction with respect to the Zₛₐ direction, an unintentional movement in the Yₛₐ direction is the different axis movement component.

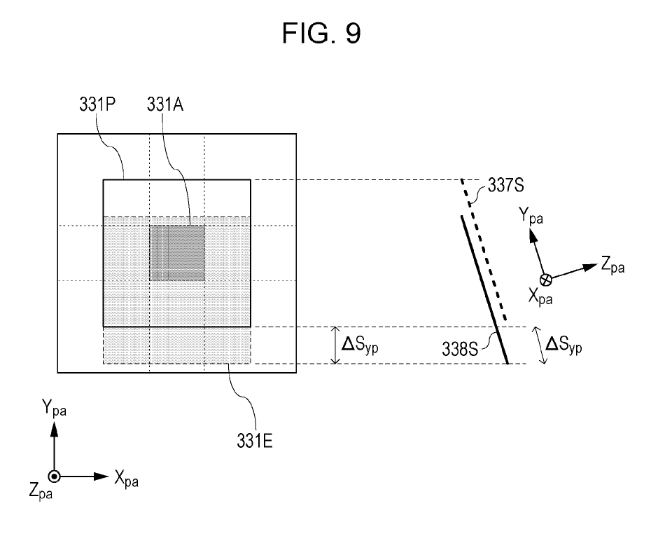

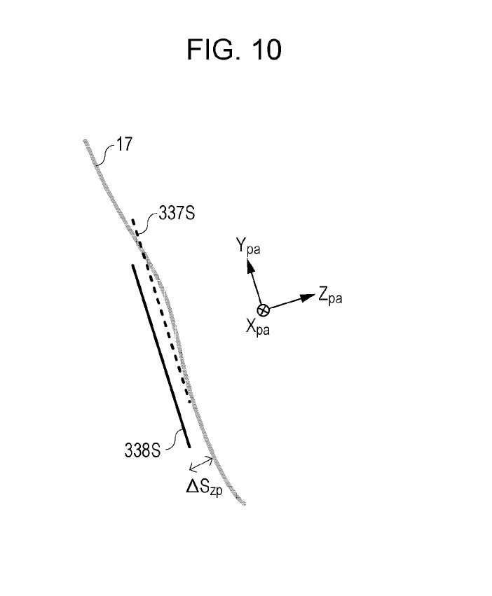

Problems occurring because of the presence of the different axis movement component will be described with reference to FIG. 9 to FIG. 10. FIG. 9 is an explanatory drawing illustrating a relationship between the sample 11 and the image taking area of the image taking unit 103. FIG. 10 is an explanatory drawing illustrating a relationship between the imaging surface of the optical flux from the sample 11 and the image taking surface of the image taking element 33. In FIG. 9 and FIG. 10, the description will be given with the image taking surface of the image taking element 33 as an Xₚₐ-Yₚₐ surface, and the direction perpendicular to the image taking surface is a Zₚₐ direction. Axes Xₚₐ, Yₚₐ, and Zₚₐ are axes with reference to the image taking surface of the image taking element 33, and are inclined with respect to the axes Xₛₐ, Yₛₐ, and Zₛₐ with reference to the movement of the stage 104 by an amount controlled to the target posture.

As illustrated in FIG. 9, the image taking area of the image taking element 33 becomes an area 331E which is displaced in position from an area 331P in the target position in the −Yₚₐ direction by an amount of ΔS_{yp} by a generation of the different axis movement component ΔS. The different axis movement component as described above may be generated in all the directions in the image taking surface. Therefore, assuming the maximum amount of movement of each direction, the area which can be used for acquiring the image is an area 331A in the image taking area of the image taking element 33, and an entire pixel area of the image taking element 33 cannot be used effectively.

As illustrated in FIG. 10, the image taking surface of the image taking element 33 becomes the reached position 338S moved from the target position 337S of the image taking surface in the target posture by ΔS_{zp} in the −Zₚₐ direction. Therefore, the image taking surface of the image taking element 33 moves away from an imaging surface 17 on which the optical flux from the sample 11 images, and the blurring image is acquired.

Accordingly, in order to solve such a problem, the control unit 106 includes the calculating unit 63. The calculating unit 63 calculates a correction value with which the mechanism control unit 64 controls a correcting mechanism 335 so that the image taking unit 103 can take the image at a posture in which a misalignment due to the different axis movement component is alleviated. Specifically, the calculating unit 63 calculates the target image data which is expected to be acquired when the image taking unit 103 takes an image of the chart 108 in the target posture from the known drawing information of the chart 108 and the control target value of the image taking unit 103.

In contrast, the calculating unit 63 acquires the reached image data obtained by the image taking unit 103 as a result of image taking of the chart 108 having known drawing information in a reached posture reached after the image taking unit 103 is controlled in accordance with the control target value. The calculating unit 63 compares the target image data and the reached image data, analyzes the different axis movement component superimposed with the reached posture of the image taking surface of the image taking unit 103, and calculates the correction value.

On the basis of the correction value, the apparatus 100 is controlled via the mechanism control unit 64 to bring the posture of the image taking unit 103 into a state in which the different axis movement component is reduced, so that a desirable image with less blurring can be obtained while effectively using the pixel area of the image taking element.

The mechanism control unit 64 controls the changing mechanism 334A to 334C and the correcting mechanisms 335A to 335C configured to move the stage 104 and the image taking unit 103 on the basis of the result of calculation of the calculating unit 62 and the result of calculation of the calculating unit 63.

The display unit 107 has a function to display the observation image suitable for pathological diagnosis on the basis of the observation image data that the generating unit 61 has generated. The display unit 107 may be composed of a monitor such as a CRT or liquid crystal.

A member on which chart patterns are drawn by a general fine machining such as laser processing or photo-etching may be used as the chart 108. The chart 108 is installed on the stage 104, and is configured to be arranged within the image taking executing range while the mount 101 is arranged within the preliminary measurement range. Alternatively, the chart 108 may be configured to be arranged in the image taking executing range after the control target value is calculated by the calculating unit 62 until the mount 101 is moved to the image taking executing range. The image of the chart 108 is taken by the image taking unit 103 in a state of having reached the reached posture and the calculating unit 63 acquires the reached image data.

The drawing information of the chart 108 is memorized in a memory 65 of the control unit 106. The calculating unit 63 calculates the target image data which is expected to be acquired when the image of the chart 108 is taken in a state in which the image taking unit 103 reaches the target posture from the drawing information and the control target value of the image taking unit 103.

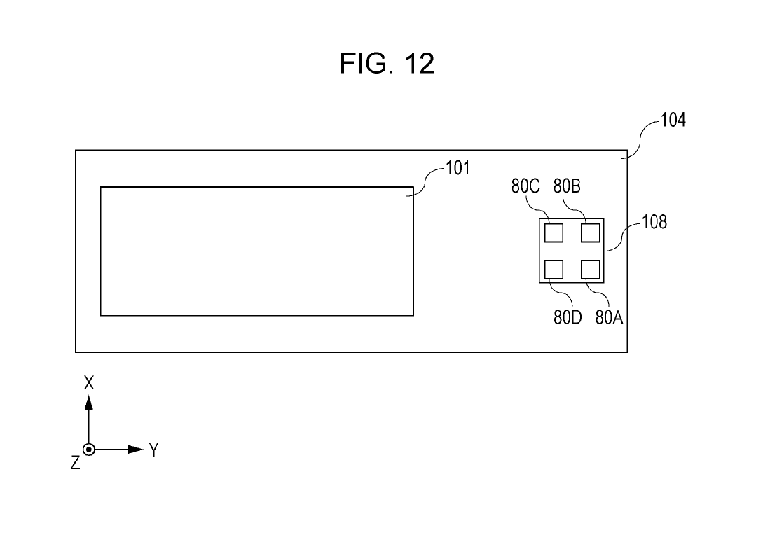

FIG. 12 illustrates an example of the chart 108. As illustrated in FIG. 12, the chart 108 includes drawing portions 80A to 80D, and each of which corresponds to the areas on the object side, which the individual image taking units 103A to 103D can take the image. The chart 108 is arranged within the image taking executing range so that the XY centers of the drawing portions 80A to 80D are aligned with the XY positions, which correspond to the object side of the ideal center of rotation of the image taking surfaces of the individual image taking units 103A to 103D. The XY centers of the drawing portions 80A to 80D and the XY positions, which correspond to the object side of the ideal center of rotation of the image taking surfaces of the individual image taking units 103A to 103D do not necessarily have to be aligned completely and only need to be aligned substantially.

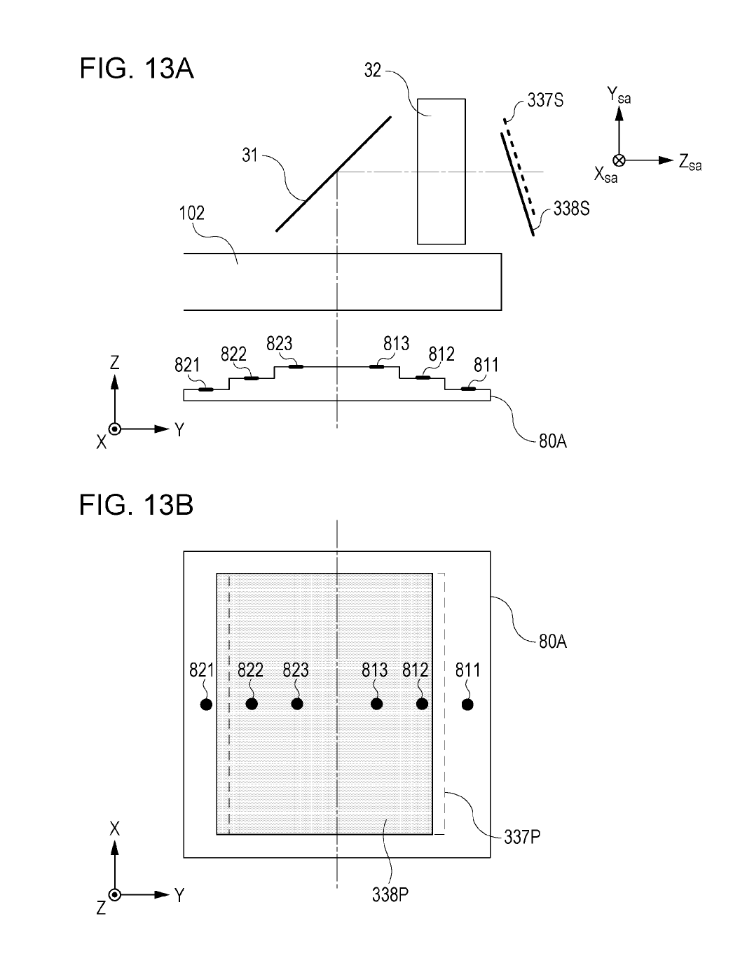

FIG. 13A illustrates an example of the drawing portion 80A, and FIG. 13B illustrates a relationship between the image taking surface and the chart 108. As illustrated in FIG. 13A and FIG. 13B, the drawing portion 80A has patterns 811 to 813, and 821 to 823 arranged on the surface thereof. A transparent member is used as the base material of the chart 108, and the patterns 811 to 813, and 821 to 823 are machined so as to have a lower transmissivity than the base material. Alternatively, it is also possible to set the transmissivity of the base material to be low and the transmissivity of the base material to be high. Here, the pattern 811 and the pattern 821, the pattern 812 and the pattern 822, and the pattern 813 and the pattern 823 are arranged at the same position (height) in the Z direction, respectively. As illustrated in FIG. 13B, which illustrates the drawing portion 80A viewed in the Z direction, the pattern 811 and the pattern 821, the pattern 812 and the pattern 822, and the pattern 813 and the pattern 823 are arranged line symmetry with respect to an axis of a straight line (straight line in the X direction) orthogonal to the Z direction, respectively.

The patterns 811 and 821 out of the patterns 811 to 813, and 821 to 823, which are arranged at the lowest positions, may be determined so as to match the height of the assumed lowest surface of the sample 11 (the upper surface of the slide glass). The patterns 813 and 823 arranged at the highest positions may be determined so as to match the assumed uppermost surface of the sample 11. The patterns 811 and 821 arranged on the outermost side in the Y direction may be determined on the basis of the range of pixel area of the image taking element 33 of the individual image taking unit 103A in the Yₚₐ direction.

In addition, FIG. 13A and FIG. 13B illustrate a difference between the target posture and the reached posture when the image taking surface of the individual image taking unit 103A is moved in the θxₛₐ direction. An image taking surface 338S in the reached posture that the individual image taking unit 103A has actually reached has a different axis movement component in the −Yₛₐ direction with respect to an image taking surface 337S that the individual image taking unit 103A should reach when moving about the ideal center of rotation. Therefore, the projection area (image taking area) on the drawing portion 80A on which the image taking surface 338S is projected via the re-imaging system 32, the reflecting member 31, and the objective lens 102, is an area 338P, which is deviated from an image taking area 337P in the target posture in the Y axis direction.

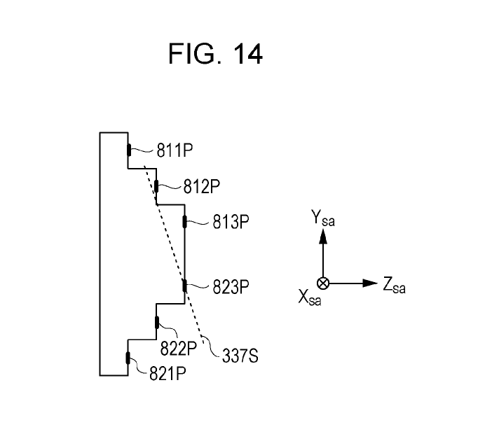

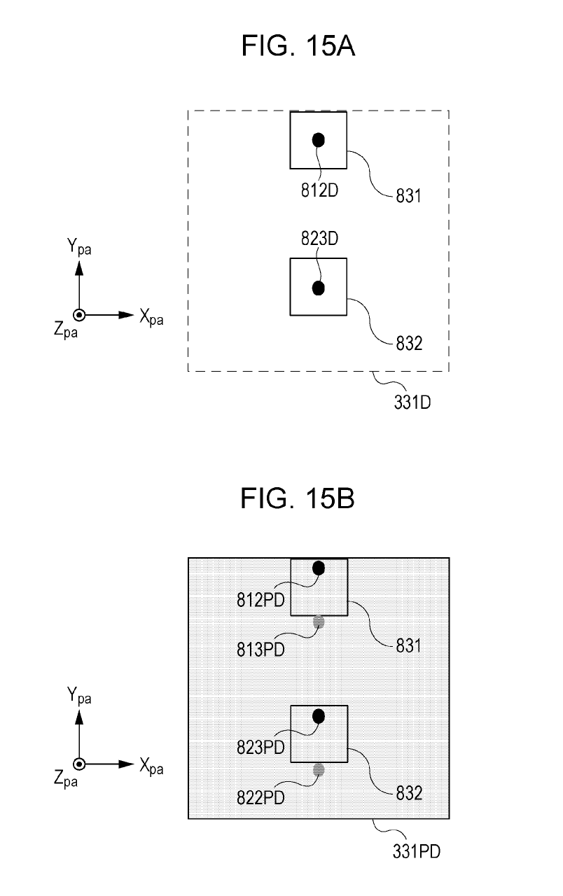

FIG. 14 illustrates a relationship between the imaging surfaces of the optical flux from each of the patterns 811 to 813, and 821 to 823 and the image taking surface of the individual image taking unit 103A. The patterns 811 to 813, and 821 to 823 are imaged at the objective lens 102, respectively, and form imaging surfaces 811P, 812P, 813P, 821P, 822P, and 823P. As illustrated in FIG. 14, if the image taking surface of the individual image taking unit 103A is in the state of the image taking surface 337S, the imaging surfaces 812P and 823P are projected on the image taking surface, and the image data is acquired. The image data to be acquired will be described with reference to FIG. 15A and FIG. 15B.

FIG. 15A illustrates a target image data 331D which is expected to be acquired when the image of the drawing portion 80A is taken in a state in which the image taking unit 103 takes the target posture (in the state in which the image taking unit 103 takes an image of the image taking area 337P). FIG. 15B is a reached image data 331PD obtained as a result of taking the image of the drawing portion 80A in a state in which the image taking unit 103 takes the reached posture (in the state in which the imaging surface of the image taking unit 103 is the image taking surface 338P).

The target image data 331D is capable of acquiring from the positional information on the respective patterns memorized in the control unit 106 and the image taking area 337P on the basis of the control target value of the image taking unit 103 by the calculating unit 63. As illustrated in FIG. 15A, pattern data 812D and 823D corresponding to the patterns 812 and 823 are reflected on the target image data 331D. Although pattern data 812PD and 823PD corresponding to the patterns 812 and 823 are reflected also on the reached image data 331PD, the pattern data 812PD and 823PD are different in position from the pattern data 812D and 823D of the target image data 331D (FIG. 15B). This is because the individual image taking unit 103A is displaced from the target posture by the different axis movement component. In other words, the calculating unit 63 compares the target image data 331D and the reached image data 331PD, whereby the different axis movement component superimposed with the reached posture of the image taking surface of the image taking unit 103 is allowed to be analyzed.

Specifically, the difference between the center of the pattern data 812D and the center of the pattern data 812PD are determined as the different axis movement component. At this time, the same difference may be obtained by using the pattern data 823D and the pattern data 823PD to calculate the different axis movement component from the result of the difference therebetween. When comparing the target image data 331D and the reached image data 331PD, the areas used for comparison is preferably set to areas 831 and 832 so that two or more pattern data is not included. The blurred pattern data 813PD and 822PD acquired from the pattern 813 and 822 are reflected on the reached image data 331PD. However, these pattern data 813PD and 822PD are preferably removed from the object used for the analysis of the different axis movement component.

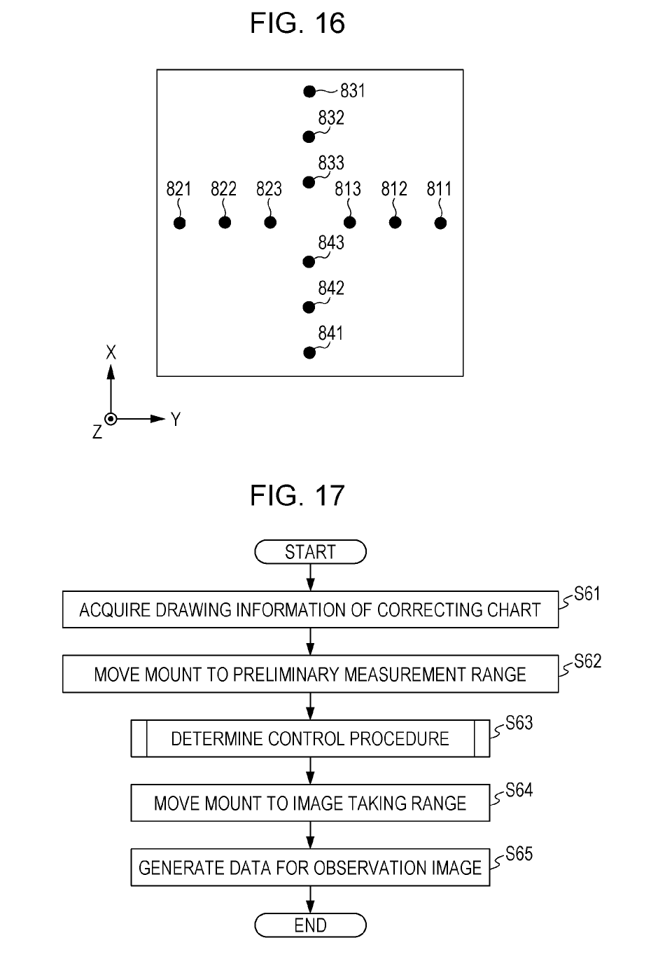

The example of the case where the image taking surface of the individual image taking unit 103A is moved in the θXₛₐ direction has been described. This disclosure is also applicable to the case where the image-taking surface is moved in the θyₛₐ direction and the both direction by configuring the drawing portion 80A as illustrated in FIG. 16 and analyzing together with the difference of the pattern data in the Xₚₐ direction. The drawing portions 80B to 80D also have the same configuration as the drawing portion 80A. In this configuration, the misalignment caused by the different axis movement component generated by the change in posture may be corrected in any of the individual image taking units 103A to 103D.

The specific number of the patterns and the positional relationship of the drawing portions 80A to 80D are determined as needed depending on the shape and configuration of the objective lens 102 or the image taking unit 103. FIG. 16 illustrates a modification of the drawing portions 80A to 80D. The drawing portion of this modification includes patterns 831 to 833, 841 to 843 in addition to the patterns illustrated in FIG. 13A. The patterns 811, 821, 831, and 841, the patterns 812, 822, 832, and 842, and the pattern 813, 823, 833, and 843 are arranged at the same positions (height) in the Z direction, respectively. The pattern 831 and the pattern 841, the pattern 832 and the pattern 842, and the pattern 833 and the pattern 843 are arranged at symmetric positions with respect to the center in the X direction, respectively.

Subsequently, the image acquisition method using the apparatus 100 will be described with reference to a flowchart in FIG. 17. First of all, in step S61, the memory 65 memorizes the positional information (drawing information) about the pattern marked on the chart 108. The drawing information may be prepared on the basis of an image acquired by taking the image of the chart 108 under a stable temperature environment by using an apparatus different from the apparatus 100 which does not cause the misalignment of the image taking element 33. The different apparatus used here also have a plurality of image taking elements, and the plurality of the image taking elements correspond to the plurality of the individual image taking units of the apparatus 100 respectively.

The acquisition of the drawing information of the chart 108 may be performed with a different apparatus as described above, or the corresponding function may be mounted on the control unit 106 of the apparatus 100. Alternatively, without using the different apparatus as described above, a configuration in which the apparatus 100 is used, the image of the chart 108 is taken under a stable temperature environment in a reference posture, and the drawing information corresponding to this image is prepared and memorized is also applicable. In addition, without taking the image by using the apparatus 100 or the different apparatus, a configuration in which the drawing information is memorized on the basis of design data when manufacturing the chart 108 is also applicable. The drawing information may be entered as needed via the interface, which is not illustrated, without being memorized in the memory of the apparatus 100.

In this manner, the step S61 is a preparatory step of an image acquisition action of the apparatus 100. Whether or not the action of step S61 is to be performed may be selected every time when the image is acquired, or step S61 may be performed only at the time of adjustment for the first time, such as at the manufacture.

In the next step S62, the mechanism control unit 64 controls the stage 104 so as to move the mount 101 to the preliminary measurement range. In the preliminary measurement range, the preliminary measuring unit 105 performs a preliminary measurement of the mount 101.

In the nest step S63, the calculating unit 62 determines the control procedure for the stage 104 and the movement mechanism 330. Specifically, the calculating unit 62 determines the surface to be imaged 15 that generates the observation image data of the sample 11 included in the mount 101 on the basis of the preliminary measurement result, and calculates the imaging surface via the objective lens 102 and the re-imaging system 32 for taking the image of the surface to be imaged 15. On the basis of the results described above, the calculating unit 62 determines a control procedure for the position changing unit 104 and the changing mechanism 334A to 334C by the mechanism control unit 64 for acquiring data of the image of the surface to be imaged 15 as a control target value table.

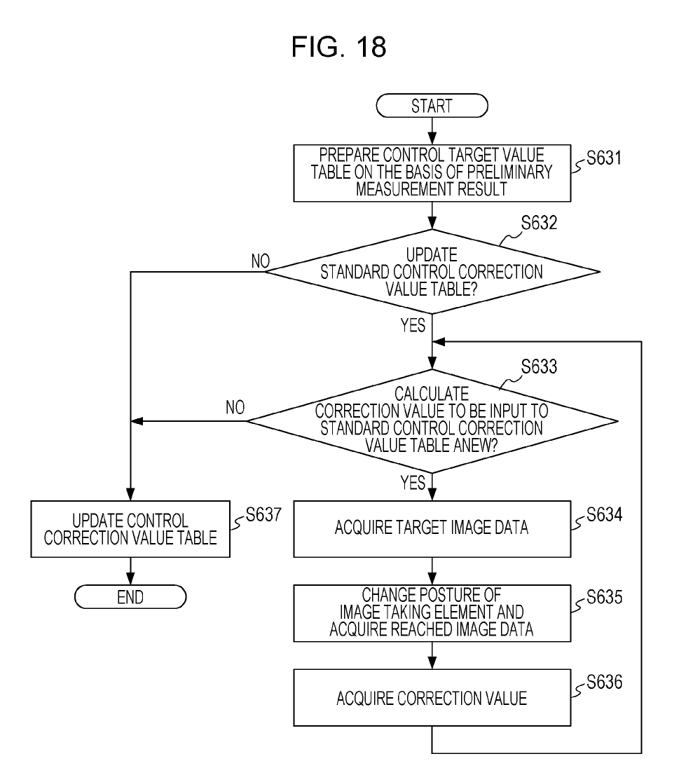

In contrast, the image taking unit 103 takes an image of the chart 108 within an image taking range. On the basis of the results described above, the calculating unit 63 determines the control procedure for the correcting mechanism 335 by the mechanism control unit 64 as the control correction value table. A method of determining the control procedure in step S63 will be described later with reference to FIG. 18.

In the next step S64, the mechanism control unit 64 controls the stage 104 so that the mount 101 moves to the image taking range. Then, the image taking unit 103 takes an image of the mount 101. Here, in accordance with the procedure determined in step S63 (the control target value table that moves the stage 104), the stage 104 is controlled so that the relative position between the mount 101 and the image taking unit 103 changes.

At the same time as the respective movement of the stage 104, the posture of the image taking unit 103 is controlled in accordance with the procedure determined in step S63 (the control target value table and the control correction value table that move the image taking unit 103). At the completion of the control described above, the image taking unit 103 takes an image of the mount 101, and the control unit 106 acquires the divided image data from the image taking unit 103.

In the final step S65, positions of a plurality of divided image data acquired in step S64 are aligned and these divided image data are connected to generate the observation image data so as to be displayed in the display unit 107. The action of connecting the divided image data may be performed in parallel to the acquisition of the image data in step S64.

FIG. 18 illustrates a flowchart for explaining details of determination of the control procedure taken by the apparatus 100 for acquiring the image data in step S63.

In step S631, the calculating unit 62 calculates the surface to be imaged 15 that generates the observation image data of the sample 11 included in the mount 101 and the imaging surface via the objective lens 102 and the re-imaging system 32 on the basis of the preliminary measurement result. Subsequently, in order to control the movements of the stage 104 and the changing mechanism 334A to 334C of the image taking unit 103, the control target value table as shown in Table 1 will be prepared. Table 1 includes control target values for moving the stage 104 and the image taking unit 103 for aligning the unit areas (image taking areas) that the respective individual image taking units 103A to 103D can take images with the divided areas in the surface to be imaged 15 in a predetermined order for each control procedure.

TABLE 1

| | CONTROL | | | CONTROL TARGET | | | | | |
|---|---|---|---|---|---|---|---|---|---|
| ORDER | TARGET VALUE | | | VALUE FOR MOVEMENT | | | | | |
| OF | FOR STAGE | | | MECHANISM | | | | | |
| CONTROL | X | Y | Z | Zₛₐ₁ | Zₛₐ₂ | Zₛₐ₃ | . . . | | |
| 1 | X[1] | Y[1] | Z[1] | Zₛₐ₁[1] | Zₛₐ₂[1] | Zₛₐ₃[1] | . | . | . |
| 2 | . | . | . | . | . | . | . | . | . |
| . | . | . | . | . | . | . | . | . | . |
| . | . | . | . | . | . | . | . | . | . |
| . | . | . | . | . | . | . | . | . | . |
| N | X[N] | Y[N] | Z[N] | Zₛₐ₁[N] | Zₛₐ₂[N] | Zₛₐ₃[N] | . | . | . |
| . | . | . | . | . | . | . | . | . | . |
| . | . | . | . | . | . | . | . | . | . |

TABLE 2

| | | |
|---|---|---|
| STANDARD CONTROL | STANDARD CONTROL | |
| TARGET VALUE FOR | CORRECTION VALUE FOR | |
| MOVEMENT MECHANISM | CORRECTION MECHANISM | . . . |

| | | | | | | | |
|---|---|---|---|---|---|---|---|
| Zₛₐ₁T | Zₛₐ₂T | Zₛₐ₃T | X_{saT} | Y_{saT} | . | . | . |
| Zₛₐ₁[0] | Zₛₐ₂[0] | Zₛₐ₃[0] | . | . | . | . | . |
| Zₛₐ₁[1] | Zₛₐ₂[0] | Zₛₐ₃[0] | . | . | . | . | . |
| . | . | . | . | . | . | . | . |
| Zₛₐ₁[n] | Zₛₐ₂[0] | Zₛₐ₃[0] | X_{sa1T}[n] | Y_{sa1T}[n] | . | . | . |
| . | . | . | . | . | . | . | . |
| . | . | . | . | . | . | . | . |
| Zₛₐ₁[0] | Zₛₐ₂[1] | Zₛₐ₃[0] | . | . | . | . | . |
| . | . | . | . | . | . | . | . |
| Zₛₐ₁[0] | Zₛₐ₂[n] | Zₛₐ₃[0] | X_{sa2T}[n] | Y_{sa2T}[n] | . | . | . |
| . | . | . | . | . | . | . | . |
| Zₛₐ₁[0] | Zₛₐ₂[0] | Zₛₐ₃[1] | . | . | . | . | . |
| . | . | . | . | . | . | . | . |
| Zₛₐ₁[0] | Zₛₐ₂[0] | Zₛₐ₃[n] | X_{sa3T}[n] | Y_{sa3T}[n] | . | . | . |
| . | . | . | . | . | . | . | . |
| . | . | . | . | . | . | . | . |

In the following step S632, the calculating unit 63 determines whether or not a standard control correction value table is to be updated as a previous step for updating the control correction value table at a posture of the image taking unit 103. In the standard control correction value table, relationship information between the control target values (standard control target values) in the range assumed for the changing mechanism 334A to 334C and the correction values (standard control correction value) required when being controlled on the basis of the respective standard control correction values are listed as Table 2, for example. In Table 2, an example in which the standard control correction value required was (X_{sa1T}[n], Y_{sa1T}[n]) in the case where the respective changing mechanism 334A to 334C of the individual image taking unit 103A were controlled with the standard control target value (Z_{sa1T}[n], Z_{sa2T}[0], Z_{sa3T}[0]) is shown.

In the case where the calculating unit 63 determines that update of the standard control correction value table is not necessary, the procedure goes to step S637, and the calculating unit 63 updates the control correction value table on the basis of the current standard control correction value table. In the case where the calculating unit 63 determines that update of the standard control correction value table is necessary, the procedure goes to step S633, and the calculating unit 63 starts acquisition of the correction value to be listed in the standard control correction value table. In the subsequent step S633, the calculating unit 63 determines whether or not the standard control correction value to be listed in the standard control correction value table is to be newly calculated.

In the case where the calculating unit 63 determines that new calculation of the standard control correction value is necessary, the calculating unit 63 determines a standard control target value for newly calculating the standard control correction value from the standard control correction value table. Then, the procedure goes to step S634, where acquisition of the correction value for the determined standard control target value is started. In contrast, in the case where the calculating unit 63 determines that new calculation of the standard control correction value is not necessary, the procedure goes to step S637, and the calculating unit 63 updates the control correction value table on the basis of the current standard control correction value table.

In step S634, the calculating unit 63 acquires the target image data. Specifically, the calculating unit 63 acquires target image data acquired when the image taking unit 103 takes an image of a chart in the target posture with the standard control target value selected from the drawing information of the chart 108 stored in step S61 and the standard control target value selected in step S633.

In the next step S635, the mechanism control unit 64 controls the image taking unit 103 on the basis of the standard control target value determined in step S633. Then, an image of the chart 108 is taken in the reached posture to acquire the reached image data.

In the following step S636, target image data acquired in step S634 and reached image data acquired in step S635 are compared, and analyzes the different axis movement component superimposed with the reached posture of the image taking unit 103. Then, a correction value to be allocated to the standard control target value selected in step S633 is calculated. Subsequently, the posture of the image taking element 33 is corrected on the basis of the calculated standard control correction value, and, a sequence in which a flow of steps S635 to S636 is performed again in this state, and a re-calculated correction value is reflected on the standard control correction value calculated before may be performed. Alternatively, a sequence may be repeated until an amount of change of the re-calculated correction value and the standard control correction value calculated before becomes a predetermined value or lower.

In step S637, on the basis of the current standard control correction value table, the control correction value table for correcting the posture of the image taking unit 103 as shown in Table 3 is updated. In Table 3, control correction values of the respective correction mechanism for correcting the posture of the image taking unit 103 are listed according to the order of control recorded in the control target value table (Table 1).

TABLE 3

| | CONTROL CORRECTION VALUE FOR | | | |
|---|---|---|---|---|
| ORDER OF | CORRECTION MECHANISM | | . . . | |
| CONTROL | Xₛₐ | Yₛₐ | . | . |
| 1 | Xₛₐ[1] | Yₛₐ[1] | . | . |
| 2 | . | . | . | . |
| . | . | . | . | . |
| . | . | . | . | . |
| . | . | . | . | . |
| N | Xₛₐ[N] | Yₛₐ[N] | . | . |
| . | . | . | . | . |
| . | . | . | . | . |

In order to update the control correction value table on the basis of the standard control correction value table, a general interpolation may be used. For example, in the examples in Table 1 to Table 3, the control correction value Xₛₐ[N] in the Xₛₐ direction listed in the Nth order of control is obtained by Expression (1).

Xₛₐ[N]=X_{sa1T}[N]+X_{sa2T}[N]+X_{sa3T}[N] (1)

where: the control correction value of the changing mechanism 334A is X_{sa1T}[N], the control correction value of the changing mechanism 334B is X_{sa2T}[N], and the control correction value of the changing mechanism 334C is X_{sa3T} [N].

Here, the control correction values X_{sa1T}[N], X_{sa2T}[N], X_{sa3T}[N] are expressed respectively by Expressions (2) to (4).

X_{sa1T}[N]=X_{sa1T}[n]+a₁*(X_{sa1T}[n+1]−X_{sa1T}[n]) 0<a₁<1 (2)

X_{sa2T}[N]=X_{sa2T}[n]+a₂*(X_{sa2T}[n+1]−X_{sa2T}[n]) 0<a₂<1 (3)

X_{sa3T}[N]=X_{sa3T}[n]+a₃*(X_{sa3T}[n+1]−X_{sa3T}[n]) 0<a₃<1 (4)

Since the target control values Zₛₐ₁[N], Zₛₐ₂[N], and Zₛₐ₃[N] of the changing mechanisms 334A to 334C for achieving the target posture can be expressed by Expression (5) to (7), a coefficient a₁, a₂, and a₃ can be obtained.

Zₛₐ₁[N]=Zₛₐ₁[n]+a₁*(Zₛₐ₁[n+1]−Zₛₐ₁[n]) (5)

Zₛₐ₂[N]=Zₛₐ₂[n]+a₂*(Zₛₐ₂[n+1]−Zₛₐ₂[n]) (6)

Zₛₐ₃[N]=Zₛₐ₃[n]+a₃*(Zₛₐ₃[n+1]−Zₛₐ₃[n]) (7)

The control correction values in the Yₛₐ direction can be obtained in the same manner.

The update of the standard control correction table by the flow in steps S633 to S636 may be performed selectively depending on whether it is necessary or not every time when acquiring the image, or may be performed only at the time of adjustment for the first time such as the time of manufacture. Alternatively, it is also possible to make the standard control target value of the standard control correction value table match the control target value of the image taking unit 103 listed in the control target value table prepared in step S632, and uses the updated standard control correction value table as the control correction value table as-is. In this case, the update of the control correction value table by the flow in steps S633 to S636 is performed every time when the image acquisition action is performed. However, a correction value in compliance with the actually controlled target posture, and corresponding to the different axis movement component having lower regularity can be obtained.

Alternatively, an abnormal control target value is selected from the control target values for the image taking unit 103 listed in the control target value table prepared in step S632 is added to the standard control correction value table. Then, it is also applicable to calculate the correction value for the abnormal control target value selectively by each of the image acquisition actions, and reflect the result to the control correction value table as-is.

Here, the abnormal control target value is a control target value which specifically requests a posture having low regularity in comparison with other control target values, and can be determined from specifications of a control mechanism and the correcting mechanism or a calculated history of the movement component when the control target value is calculated in step S632. Alternatively, when where the control target value is calculated in step S632, in the case where the difference in comparison result is a predetermined value or larger in comparison with the plurality of the standard posture target values of the standard control correction table, the corresponding value may be determined as the abnormal posture target value.

In this manner, in the image acquiring apparatus configured to be capable of changing the position of the image taking element in the direction of the optical axis and the inclination of the image taking element with respect to the optical axis so as to follow the waviness of the surface to be imaged 15 of the sample 11 included in the mount 101, the displacement caused by the different axis movement component can be corrected.

Accordingly, images having less burring in the respective postures can be acquired, and the pixels of the image taking element can be effectively used.

Specifying the posture of a substance moving with the different axis movement component such as the image taking element 33 superimposed therewith by the measurement of the angle as needed is difficult in many cases. Therefore, providing the measuring device in the direction other than the direction of the drive axis may become disadvantageous in terms of space and cost. According to the apparatus 100, it is not necessary to provide the measuring device for measuring the angle, and the posture of the image taking element 33 can be corrected easily.

The example of enabling the acquisition of the image in which the influence of the waviness of the surface to be imaged 15 of the sample 11 included in the mount 101 is suppressed by bringing the image taking surface to approach to the imaging surface by performing change control and correction control on the posture of the image taking elements 33 that the respective individual image taking unit have has been described. For example, however, the same effects are also achieved by performing the movement control and the correction control on the position and the posture of the stage 104, the reflecting member 31, and the re-imaging system 32 or by combining these controls. For example, with a configuration in which the imaging surface is brought to approach to the image taking surface by the movement control on the posture of the reflecting member 31 and the different axis movement component generated at the time is corrected by performing the movement control on the position of the image taking element 33, the arrangement and the configuration of the respective members may be optimized. Also, by using a parallel link mechanism, an integral configuration of the changing mechanism 334A to 334C and the correcting mechanism 335 is also applicable.

Although the individual image taking unit group in which the image taking elements are arranged two dimensionally has been described, the individual image taking unit group in which the image taking elements are arranged one dimensionally or three dimensionally may also be used. Although two dimensional image taking element is used as the image taking element, a one-dimensional image taking element (line-sensor) may also be used.

### Second Embodiment

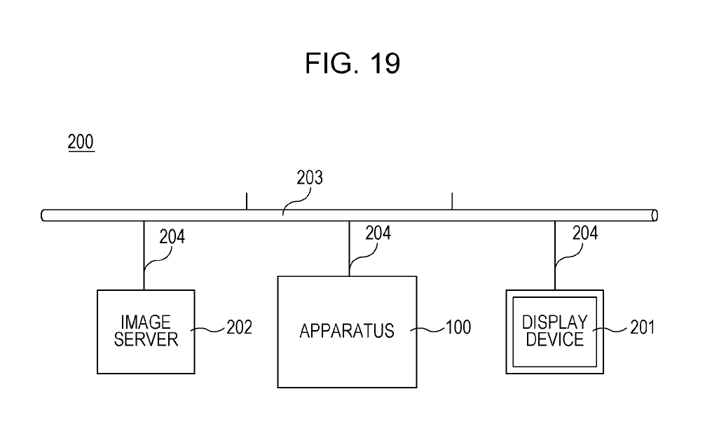

FIG. 19 is a drawing of an image acquiring system 200 (hereinafter, referred to as “system 200”) as a second embodiment for realizing this disclosure. This embodiment will be described below with reference to FIG. 19.

The system 200 includes the apparatus 100, a display device 201, and an image server (image memory device) 202. The apparatus 100, the display device 201, and the image server 202 are connected by a general-purpose LAN cable 204 via a network 203. Alternatively, a configuration in which between the image server 202 and the apparatus 100 or between the apparatus 100 and the display device 201 is connected with a general-purpose I/F cable is also applicable.

The image server 202 has a function to store the observation image data generated by the apparatus 100. The apparatus 100 has a function (not illustrated) to acquire the observation image data from the image server 202 and to re-edit the observation image data for displaying the image or information suitable for the pathological diagnosis in addition to the function described in the first embodiment. Other configurations are the same as those of the apparatus 100 described in conjunction with FIG. 1, and hence detailed description will be omitted.

The display device 201 is equivalent to the display unit 107, and has a function to display the observation image suitable for the pathological diagnosis on the basis of the observation image data that the apparatus 100 has generated. The display device 201 includes an interface, which is not illustrated, which allows the user to change the setting of the apparatus 100 or to input drawing information of the chart 108. A monitor which constitutes part of the display device 201 may be configured as a touch panel.

In the system 200 configured in this manner, components can be arranged remotely, so that the user is capable of acquiring images or displaying images by a remote control.

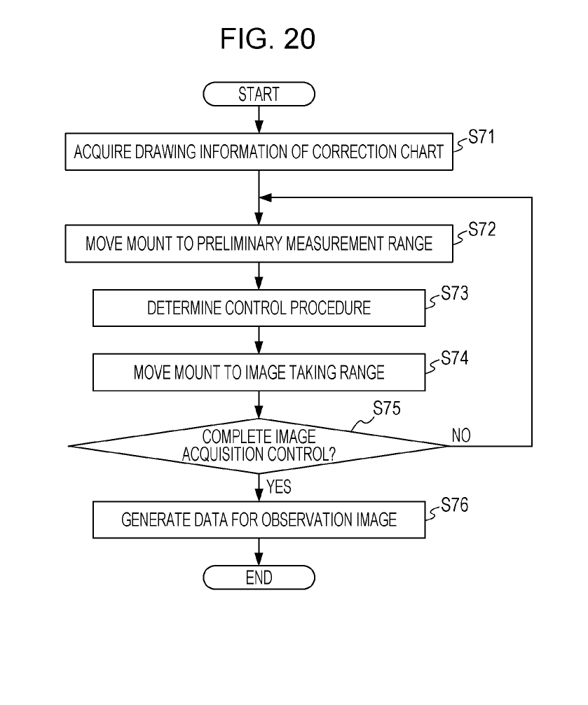

An image acquiring method of the system 200 will be described with reference to a flowchart illustrated in FIG. 20. First of all, in step S71, the memory 65 memorizes the positional information (drawing information) on the pattern marked on the chart 108. This procedure is the same as step S61 described in conjunction with FIG. 17, and is acquired in advance. Therefore, if the re-acquisition is not necessary, this procedure may be omitted. In the next step S72, the stage 104 is controlled so that the mechanism control unit 64 moves the mount 101 to a range (preliminary measurement range) in which the preliminary measurement unit 105 can execute the preliminary measurement. This procedure is the same as step S62 described in conjunction with FIG. 17.

In the next step S73, the calculating unit 62 determines the control procedure which moves the stage 104 and the image taking unit 103 as shown in Table 1 on the basis of the preliminary measurement result. This procedure is the same as in steps S631 to S636 described in conjunction with FIG. 18. However, the update of the control target value table to be performed in step S631 may be once at the beginning for every image acquisition action. In this embodiment, determination to be performed in steps S632 and S633 and the update of the control correction value table to be performed in step S637 are not performed, and the calculating unit 63 selects a control target value for taking an image of the divided areas which is subjected to the image taking immediately after. Calculation of the correction value for the control target value selected here is performed. A method of acquiring the correction value is the same as steps S634 to S636.

In the next step S74, the mechanism control unit 64 controls the stage 104 and the changing mechanism 334A to 334C so that the mount 101 moves to the image taking range of the image taking unit 103. The correcting mechanism 335 is controlled on the basis of the correction value acquired in step S73. Subsequently, the image taking unit 103 takes an image of the mount 101, and the generating unit 61 acquires the divided image data, which is an image taking result of the image taking unit 103.

In the next step S75, the generating unit 61 determines whether or not a series of the image acquisition control listed in the control target value table updated in step S73. In other words, the generating unit 61 determines whether or not there is an area whereof the image is to be taken among the divided areas in the surface to be imaged 15. When it is determined that the image acquisition control is to be completed, the procedure goes to step S76, and the generating unit 61 generates observation image data. When it is determined that the image acquisition control is not to be completed, the procedure goes to step S72, where the image acquisition process in compliance with the control target value table is continued. In this case, a control target value corresponding to the divided area whereof the image is to be taken next is selected from the control target value table to acquire a correction value corresponding to the control target value.

In the final step S76, positions of a plurality of divided image data acquired in the flow from steps S72 to S75 are aligned, the divided data are connected to generate the observation image data so as to be displayed in the display unit 107. The action of connecting the divided image data may be performed in parallel to the acquisition of the divided image data in the flow of the steps S72 to S75.

In the case of the second embodiment, since the steps S72 to S74 are repeated, the stage 104 is moved to the range where the images of the chart 108 and the mount 101 can be taken every time where the posture control of the image taking unit 103 is performed. However, acquisition of a correction value corresponding to the different axis movement component which has low reproducibility is achieved in compliance with the posture which is actually reached. In combination with the image acquisition method of the first embodiment, the flow of the steps S72 to S74 may be performed selectively only for the posture control of the abnormal control target value which is expected to have low reproducibility.

In this manner, in the image acquiring apparatus configured to be capable of changing the position of the image taking element in a direction of the optical axis and the inclination of the image taking element with respect to the optical axis so as to follow the waviness of the surface to be imaged 15 of the sample 11 included in the mount 101, the displacement caused by the different axis movement component can be corrected. Consequently, the pixel of the image taking element may be effectively used. In addition, images with less blurring may be obtained further stably at each postures.

### Third Embodiment

In a third embodiment, a recording medium (or a memory medium) in which a software program code which realizes the entire part or part of the functions of the respective embodiments described above is recorded is supplied to the system or the apparatus. A program is executed by computer (or a CPU or an MPU) of the system 200 or the apparatus 100 by reading and executing the program code stored in the recording medium. In this case, the program code which is read out form the recording medium realizes the function of the above-described embodiment, and the recording medium itself which records the program code constitutes part of this disclosure.

The computer executes the read-out program code, so that an operating system (OS) or the like working on the computer performs part or the entire part of the actual process. The case where the functions of the above-described embodiment are realized by the process described above is also included in this disclosure.

It is assumed that the program code read out from the recording medium is written in the memory provided on a function enhancement card inserted into the computer or a function enhancement unit connected to the computer. Subsequently, the case where the CPU or the like provided on the function enhancement card or the function enhancement unit executes part or the entire part of the actual process on the basis of the instruction of the program code whereby the above-described functions of the embodiments are realized is also included in this disclosure.

In the case where this disclosure is applied to the recording medium described above, the program code corresponding to the flowchart described above is stored in the recording medium.

### Other Embodiments

Although the preferred embodiments of this disclosure have been described, this disclosure is not limited to those embodiments, and various modifications or variations may be made within the scope of this disclosure. The configurations described in conjunction with the first to third embodiments may be combined with each other. Therefore, to configure a new system by combining various technologies as needed in the above-described embodiments may be found easily by those skilled in the art, so that systems achieved by various combinations are also included within the scope of this disclosure.

For example, in the image acquisition action of the image acquiring apparatus according to the respective embodiments described above, NA of the objective lens 102 may be set to different values when taking an image of the mount 101 and when taking an image of the chart 108, which are effective way for achieving highly accurate detection of the different axis movement component. Specifically, when taking the image of the chart 108 from which acquisition of imaged data of the intended pattern is wanted, the NA is set to a higher value than the NA selected when taking the image of the mount 101 from which the image data is acquired over the entire part of the range to be imaged. This allows acquisition of the image at a high-resolution, a different axis movement component can be detected at a high degree of accuracy.

In contrast, when taking an image of the chart 108 from which imaged data of the intended pattern is wanted in various postures, the NA is set to a larger depth of focus (lower NA) than that selected when taking an image of the mount 101 from which data is acquired in the posture following the approximate imaging surface of a range whereof the image is to be taken. In this configuration, the pattern of the chart 108 may be formed at only a single level, whereby the process can be simplified together with the process of image processing thereof and detecting the different axis movement component.

Adjustment of the NA is considered to be effective also when correcting distortions in order to detect a different axis movement component with further higher degree of accuracy. In order to detect the different axis movement component, detection of positions of centers of gravity of the respective patterns in reached image data 331PD is effective. At this time, the contrast of the reached image data 331PD may be adjusted by changing the NA, so that the accuracy of detection of the positions of the centers of gravity of the respective patterns may be enhanced.

As a configuration for adjusting the NA, an NA diaphragm which allows an arrangement of a plurality of field-of-view shielding plates having different apertures depending on the application or an iris diaphragm composed of a plurality of field-of-view shielding blades may be used. Furthermore, the imaging position of the objective lens 102 is set to different values when taking an image of the mount 101 and when taking an image of the chart 108. In this configuration, in the same manner as the NA adjustment described above, the pattern of the chart 108 may be formed at only a single level, whereby the process can be simplified together with the process of image processing thereof and detecting the different axis movement component.

A mechanism using a linear actuator having a linear motor, an air cylinder, a stepping motor, or an ultrasonic wave motor, and the like may be used as a configuration of adjusting the imaging position of the objective lens 102. Such a configuration is used at a connecting portion between a body frame, which is not illustrated, and a lens barrel of the objective lens 102, or a connecting portion between a lens and a mirror in the objective lens 102 and the lens barrel.

In the embodiments described above, the surface to be imaged 15 in the sample 11 is determined and the observation image data regarding the surface to be imaged 15 is acquired. However, this disclosure is not limited thereto, and a configuration in which the stage 104 is moved in the Z direction after the image taking following the waviness of the surface to be imaged 15, and images of a plurality of surfaces different in position in the Z direction are taken to acquire a three-dimensional image is also applicable.

In the case where the positional misalignment due to the different axis movement component is reduced with the method described in the embodiments described above, this disclosure is not limited to a configuration in which the posture of the image taking element 33 is changed as in the embodiments described thus far, and for example, and a configuration in which the posture of the stage 104 is changed is also applicable. The method described above is not limited to the positional misalignment generated by a change of the posture for causing the image taking surface of the image taking element 33 to follow the surface to be imaged 15, but may be used for reducing the positional misalignment due to the different axis movement component caused in association with the movement of the stage 104.

Furthermore, a configuration in which a plurality of charts 108 are arranged on the stage 104 and a plurality of sets of correction value groups including a plurality of correction values are acquired by using respective charts is also applicable. For example, a final correction value is acquired from a mean value in the plurality of the sets of the correction value groups. In this case, a center of gravity (center of line if there are two) of the polygon obtained by connecting centers of gravity of the plurality of the charts 108 can be matched with the center of the mount 101 or the sample 11 placed on the stage 104 or the position where a portion in the vicinity of the center is arranged.

In this configuration, a difference of the correction values caused by the difference between the position of the mount 101 and the position of the chart 108 may be reduced.

According to the image acquiring apparatus as an aspect of the present disclosure, in the image acquiring apparatus configured to be capable of changing the posture of the imaging taking unit so as to follow the waviness of the surface to be imaged of the object, a difference due to the different axis movement component which superimposes when changing the posture of the image taking unit is corrected to allow the pixels of the imaging taking unit to be used effectively.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-156794 filed Jul. 31, 2014, which is hereby incorporated by reference herein in its entirety.

What is claimed is:

1. An image acquiring apparatus configured to acquire an image of an object by joining a plurality of divided images obtained by taking images of a plurality of divided areas in the object, comprising:
an imaging optical system configured to image light from the object;
an image taking element configured to take an image of the object;
a changing mechanism configured to change a posture of the object or the image taking element;
a control unit configured to calculate a control target value for causing the changing mechanism to reach a target posture; and
a correcting mechanism configured to correct the posture such that a reached posture approaches the target posture, the reached posture is a posture of the object or the image taking element after the changing mechanism has changed the posture in accordance with the control target value, wherein
the control unit calculates a correction value of the posture by comparing reached image data obtained by the image taking element taking an image of a correction chart, the correction chart including drawing information that is known in a state that the posture is the reached posture, and target image data which is expected to be obtained when the image taking element takes an image of the correction chart in a state that the posture is the target posture, and
the correcting mechanism corrects the posture on the basis of the correction value.

2. The image acquiring apparatus according to claim 1, wherein
the changing mechanism changes the posture with one or more operating axis,
the control unit calculates a movement component of an axis different from the operating axis as the correction value, and
the correcting mechanism corrects the posture so as to reduce the movement component.

3. The image acquiring apparatus according to claim 2, wherein
the changing mechanism changes an inclination of a light receiving surface of the image taking element with respect to a direction of an optical axis of the imaging optical system with the operating axis, and
the correcting mechanism moves in a direction perpendicular to the direction of the optical axis and rotates about the optical axis of the imaging optical system.

4. The image acquiring apparatus according to claim 1, wherein
the correction value is acquired on the basis of a difference between a position of a pattern of the drawing information of the reached image data and a position of a pattern of the drawing information of the target image data, and
the correcting mechanism corrects the posture such that the position of the pattern of the reached image data approaches the position of the pattern of the target image data.

5. The image acquiring apparatus according to claim 1, wherein
the control unit controls the changing mechanism in accordance with an inclination of a surface to be imaged when acquiring an image of the object.

6. The image acquiring apparatus according to claim 1, further comprising:
a stage configured to support the object and move in the direction of the optical axis of the imaging optical system and the direction perpendicular to the direction of the optical axis, wherein
the changing mechanism and the correcting mechanism change the posture of the image taking element.

7. The image acquiring apparatus according to claim 6, wherein
the correction chart is arranged on the stage.

8. The image acquiring apparatus according to claim 1, wherein
the control unit determines an order of image taking of the plurality of the divided areas and a plurality of the control target values for changing the posture so as to approach an imaging surface of each of images of the plurality of the divided areas, and calculates a plurality of the correction values each corresponding to the respective control target values, and
the changing mechanism and the correcting mechanism change and correct the posture in accordance with the order.

9. The image acquiring apparatus according to claim 1, wherein
the control unit acquires relationship information between the plurality of the control target values and the correction values each corresponding to the respective control target values, and calculates correction values corresponding to the control target values for changing the posture such that the image taking surface of the image taking element and the imaging surface of the images in the divided areas approach each other.

10. The image acquiring apparatus according to claim 1, further comprising:
a preliminary measuring unit configured to perform measurement for determining the divided area from which an image of the object is to be acquired and measurement for acquiring information on the surface to be imaged, wherein
the control unit calculates a plurality of the control target values and the plurality of the correction values each corresponding to the respective control target values on the basis of the information on the surface to be imaged.

11. The image acquiring apparatus according to claim 1, comprising:
a plurality of the image taking elements configured to take images of the divided areas of the object different from each other; wherein
each of the plurality of the image taking elements includes the changing mechanism and the correcting mechanism.

12. The image acquiring apparatus according to claim 1, wherein
the correction chart includes a plurality of areas having different thicknesses and a plurality of patterns each arranged on respective surfaces of the plurality of the areas,
the plurality of the patterns are arranged in line symmetry with respect to a straight line perpendicular to an optical axis of the imaging optical system, and
an image of the straight line that the imaging optical system obtains by imaging light from the straight line matches an ideal center of rotation in the case of changing an inclination of the image taking element.

13. The image acquiring apparatus according to claim 10, wherein
an image taking range in which an image of the object can be taken by the image taking element and the preliminary measuring unit are arranged at different positions, and
the correction chart can be arranged within the image taking range in a state in which the object is arranged at a position which allows measurement by the preliminary measuring unit or during a movement from the position which allows the measurement by the preliminary measuring unit to the image taking range.

14. The image acquiring apparatus according to claim 6, wherein
the stage includes the plurality of the correction charts arranged thereon, and
the control unit calculates the correction value by using the reached image data obtained as a result that the image taking element has taken the plurality of the correction charts.

15. The image acquiring apparatus according to claim 14, wherein
a center of a straight line connecting centers of gravity of the plurality of the correction charts or a center of gravity of a polygon matches a center of gravity of the object arranged on the stage.

16. An image acquiring system comprising:
the image acquiring apparatus configured to acquire an image of an object; and
a display device configured to display the image of the object acquired by the image acquiring apparatus, wherein
the image acquiring apparatus comprising:
an imaging optical system configured to image light from the object;
an image taking element configured to take an image of the object;
a changing mechanism configured to change a posture of the object or the image taking element;
a control unit configured to calculate a control target value for causing the changing mechanism to reach a target posture; and
a correcting mechanism configured to correct the posture such that a reached posture approaches the target posture, the reached posture is a posture of the object or the image taking element after the changing mechanism has changed the posture in accordance with the control target value, wherein
the control unit calculates a correction value of the posture by comparing reached image data obtained by the image taking element taking an image of a correction chart, the correction chart including drawing information that is known in a state that the posture is the reached posture, and target image data which is expected to be obtained when the image taking element takes an image of the correction chart in a state that the posture is the target posture, and
the correcting mechanism corrects the posture on the basis of the correction value.

17. An image acquiring method for acquiring an image of an object by joining a plurality of divided images obtained by taking images of a plurality of divided areas in the object, comprising:
imaging light from the object;
taking an image of the object by an image taking element;
calculating a control target value for reaching a target posture of the image taking element;
changing postures of the object or the image taking element in accordance with the control target value;
comparing reached image data obtained as a result that the image taking element actually takes an image of a correction chart whereof drawing information is known in a state in which the posture is the reached posture after the change of the posture in the changing, and target image data which is expected to be obtained when the image taking element takes an image of the correction chart in a state in which the posture is the target posture to acquire a correction value of the posture; and
correcting the posture such that the reached posture approaches the target posture on the basis of the correction value.
